(19) United States
(12) Patent Application Publication
(10) Pub. No.: US 2013/0262212 A1
(43) Pub. Date: Oct. 3, 2013

(54) PUNCH CARD LOYALTY PROGRAM IN A SOCIAL NETWORKING SYSTEM

(71) Applicants: Dmitry Shevelenko, San Franicsco, CA (US); Loren Alfred Cheng, Mountain View, CA (US); Yegnashankar Parasuram, Cupertino, CA (US); Christopher Triolo, Commack, NY (US); Reshma Khilnani, San Francisco, CA (US); Edward Zagat, Mountain View, CA (US)

(72) Inventors: Dmitry Shevelenko, San Franicsco, CA (US); Loren Alfred Cheng, Mountain View, CA (US); Yegnashankar Parasuram, Cupertino, CA (US); Christopher Triolo, Commack, NY (US); Reshma Khilnani, San Francisco, CA (US); Edward Zagat, Mountain View, CA (US)

(21) Appl. No.: 13/437,823

(22) Filed: Apr. 2, 2012

(51) Int. Cl. G06Q 30/02

(52) U.S. Cl. 705/14.27

(57) ABSTRACT

A social networking systems associates users of the system with a social punch card, credits the social punch card with punches based on actions performed by the users, and provides rewards to the users when the target number of punches for the social punch card is reached. A social punch card includes a definition of an action that will credit a punch to the social punch card, a target number of punches for completing the punch card, and a reward to be provided for reaching the target number of punches. Each of the users associated with a social punch card are connected with at least one other user associated with the social punch card.

### BACKGROUND

This invention relates generally to social networking, and in particular to providing social punch cards to users of a social networking system.

Businesses have provided rewards to users on an individual basis. For example, a business establishment may provide a physical “punch card” to a customer for a free cup of coffee after the customer buys ten cups of coffee. This encourages the customer to return to the business establishment to earn the reward. While these marketing techniques are used for individuals, tools have not been developed to offer rewards to groups of users in a social networking system based on the actions of the group of users.

### SUMMARY

To leverage social connections to offer more effective loyalty programs, a social networking system enables users to earn rewards with their friends by completing social punch cards with their friends. The social networking system uses transaction data for the set of users associated with a social punch card to credit the social punch card with one or more punches. When the redemption point for the card is reached, each social card member receives a reward. Each user initiated event relating to the social punch card propagates communication between the set of users associated with the social punch card thereby generating social pressure and intensifying engagement with the social punch card promotion and/or business sponsoring the card. Each user initiated event propagates communication through the social network system thereby spreading awareness of the business sponsoring the social punch card and the promotions, discounts, and offers related to the social punch card. By sponsoring social punch cards, businesses can reach not only a target audience but the entire network of the target audience (i.e., the friends of social punch card members).

In one embodiment, a social punch card includes a definition of an action that will credit a punch to the social punch card, a target number of punches for completing the punch card, and a reward to be provided for reaching the target number of punches. The defined action may include purchase of a product or service associated with the sponsor of the social punch card. For example, the action required to receive a punch for a social punch card sponsored by a coffee business may include the purchase of a cup of coffee from the coffee business. The reward is defined by the sponsor of the social punch card and may include an offer, discount, or a credit. Using the previous example, the reward for a coffee social punch card may be a coupon for a free cup of coffee or a credit to a user's credit card account for the purchase amount of a cup of coffee. A social punch card may also define a maximum number of members for the social punch card. For example, a social punch card may have at most ten members.

Users and/or friends of social punch card members are notified when the social punch card receives a punch, when the target number of punches for the card is reached, when a new user joins the social punch card, or when users discuss the social punch card. The notifications encourages users to perform actions (e.g., making a qualifying purchase) that add punches to a social punch card and increase user engagement with a business sponsoring the social punch card. The notifications may be sent to the friends of the social punch card members in order to encourage them to join a social punch card, to spread awareness of a social punch card promotion or to spread awareness of the business sponsoring a social punch card. Users may be notified in various ways. In some embodiments, the users are notified with an overlay box displayed over a corner of their screen that includes the text of the notification. In some embodiments, the users are notified with a news story in their news feeds.

In another embodiment, the social networking system creates or selects a social punch card to assign to a user. A user may join a social punch card in several ways including being invited to a social punch card, requesting to join a particular social punch card, requesting to join any social punch card provided by a particular business, or requesting to join a social punch card without specifying a business sponsor for the card. If the user is invited to join a social punch card that has an available member spot, the user is assigned to the social punch card. If the user requests to join or is invited to a particular social punch card that does not have available member spots, the social networking system selects a social punch card to assign the user to based on the user's affinity for members of the social punch card or the social networking system creates a social punch card for the user. For example, if the user requests to join a particular social punch card sponsored by a smoothie business that does not have any available member spots, the social networking system may select another social punch card sponsored by the smoothie business that has at least one member that is friends with the user or the social networking system may create a new social punch card for the user. The social networking system scores the available social punch cards based on the user's affinity for the members of the social punch card, and selects the social punch card having the highest score. In some embodiments, the user is assigned to a social punch card that has at least one member that is friends with the user. In some embodiments, the social networking system may assign a user to a social punch card based at least in part on the number of remaining punches until the target number of punches is reached. For example, the social networking system may select the social punch card with the highest score and the least amount of remaining punches. In some embodiments, when the user requests to join a social punch card but does not specify a particular social punch card or social punch card sponsor, the social networking system may assign the user to a social punch card based on the user's interest and/or interests of users who have similar interests to the user.

### BRIEF DESCRIPTION OF THE DRAWINGS

FIG. 1 is a high level block diagram illustrating a system environment, in accordance with one embodiment of the invention.

FIG. 2 is a high level block diagram illustrating a system environment, in accordance with one embodiment of the invention.

FIG. 3 is a flow chart illustrating a process of updating a social punch card, in accordance with an embodiment of the invention.

FIG. 4 is a flow chart illustrating a process for assigning a user to a social punch card, in accordance with an embodiment of the invention.

FIG. 5 is an example screenshot of a page for a social punch card, in accordance with an embodiment of the invention.

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview

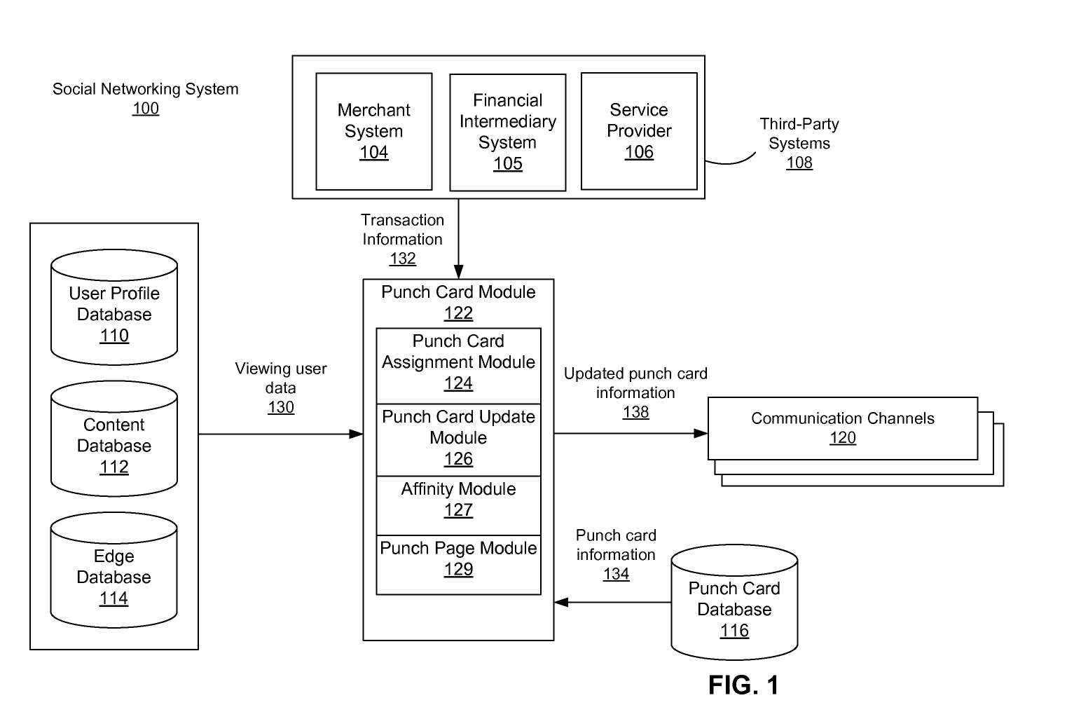

FIG. 1 is a high level block diagram of a process for updating a social punch card, in accordance with one embodiment. As illustrated in FIG. 1, the punch card module 122 receives viewing user data 130 that describes a user's actions on the social networking system 100, punch card information 134, and transaction information 132 describing transactions that took place outside of the social networking system 100. Using the viewing user data 130, the punch card information 134, and the transaction information 132, the punch card module 122 updates a social punch card with one or more punches and sends notifications containing updated punch card information 138 to one or more communication channels 120.

The punch card information 134 for a social punch card is maintained by the punch card database 116 and includes a definition of one or more actions and/or transactions that qualify as a punch on a social punch card, a target number of punches for completing the social punch card, a description of the reward to be provided for reaching the target number of punches, information about how the reward is distributed, the current number of punches for the social punch card, the remaining number of punches for the social punch card, information identifying the members or users associated with the social punch card, and the maximum number of member spots for the social punch card. The action definitions may define any action a user is capable of performing on the social networking system 100. For example, the actions may include viewing content, commenting on a post, posting content, posting a status update about a topic, joining a group, joining a fan page, attending an event, creating a page, indicating interest in a product by “liking” a product page, using a third-party application accessible via the social networking system 100, or performing a transaction in the social networking system 100. In some embodiments, the action may be performed outside of the social networking system 100. For example, the action may include a user visiting a third-party website or signing up for an offer at a third-party website. In some embodiments, the punch card information defines transactions that qualify as punches for a social punch card. The transaction may include purchases of a product or service. For example, purchasing a cup of coffee may earn a punch on a social punch card sponsored by a coffee provider. The definition for a qualify purchase may specify an item or service, the quantity of items that needs to be purchased, a time period in which the purchase must take place, a minimum amount spent in the purchase, or any combination thereof.

The target number of punches defined by the social punch card information 134 specifies the number of punches or qualifying actions required in order for the members of a social punch card to receive a reward. Using the previous example, a coffee provider may require that a group of users buy 12 cups of coffee before the group receives the reward. In some embodiments, the social punch card information 134 specifies that each member of the social punch card must contribute at least one punch to the social punch card in order for the group to receive the reward.

The punch card information 134 includes a description of the reward associated with the social punch card and instructions on how to distribute the reward. The reward may be money, credit, virtual currency, a discount, a redemption code, item, service, or any combination thereof. The reward may be distributed by the social networking system 100 or another system such as a merchant system 104, a financial intermediary system 105 or a service provider 106. As discussed in more detail herein, the reward my directly credit to a user's account. In some embodiments, the sponsor may specify the maximum cost of a free item that will be credited to a user's account as a reward.

The viewing user data 130 includes information about the user and the user's actions on the social networking system. More specifically, the viewing user data 130 may include user profile objects, edge objects, and content objects. User profile objects include declarative profile information about a user, inferred or implicit information about a user from the user's actions on the social networking system and outside of the social networking system, information about the user's activities and interests, and information about the user's friends. A user's profile object includes various fields containing different data. Examples of profile fields includes phone numbers, instant message screen names, addresses, websites, current city, hometown, gender, birthday, names of family members, languages spoke, a description, education history, work history, religious affiliations, political views, favorite quotes, favorite sports, favorite foods, favorite books, favorites movies, interests, activities, names of pets, information about friends, and the like. A user's profile object may also include the user's affinity scores for objects in the social networking system 100. An affinity score measure or indicates a user's affinity for one an object in the social networking system 100. In one embodiment, affinity scores of users for an object may be determined by the social networking system 100 based on the user's interactions with the specified object over time. In particular, affinity scores of the users for an object may be determined based on edge objects containing information describing the interactions between the user and object. The affinity scores are further described in a related application, “Contextually Relevant Affinity Prediction in a Social Networking System,” U.S. patent application Ser. No. 12/978,265, filed on Dec. 23, 2010, which is hereby incorporated by reference.

Edge objects connect objects in the social graph and include information about the viewing user's interactions with other objects on the social networking system 100, such as clicking on a link shared with the viewing user, sharing photos with other users of the social networking system, posting a status update message on the social networking system 100, and other actions that may be performed on and off the social networking system 100. Stated in another way, an edge object contains information about the history of interactions between a viewing user and an object of the social networking system 100. Edge objects may also include information about user interactions outside of the social networking system 100. For example, interaction information may be collected from third-party systems (e.g., sites and applications) that use social plug-ins that enables users to interact with social content from the social networking system 100.

Content objects include objects created by users of the social networking system 100, such as status updates that may be associated with photo objects, location objects, and other users, photos tagged by users to be associated with other objects in the social networking system 100, such as events, pages, and other users, and applications installed on the social networking system 100. In some embodiments, the content objects are received from third-party applications or third-party applications separate from the social networking system 100.

The transaction information 132 includes information describing one or more transactions. The information for a transaction may include a time and date of a transaction, a description of the item or service purchased, the number of items purchased, the purchase amount, an identifier for a user, and an identifier for the merchant. The transaction information 132 may be received from merchant systems 104, financial intermediary systems 105, or service providers 106. For convenience of explanation, the merchant systems 104, financial intermediary systems 105, and service providers 106 are referred to as third-party systems 108. A financial intermediary 105 includes an entity that handles payments such as a credit card processing system. A service provider 106 includes any entity that provides data or an online service to a user over a network, including but not limited to social networking systems, web retailers, news providers, video content item providers, etc. In order for the social networking system 100 to receive the transaction information 132 for a user, the user has to provide credit card information to the social networking system 100 which notifies the third-party systems 108 that the user has given authorization for them to provide transaction information for the user. The authorization may allow the third-party systems 108 to send the social networking system 100 information about a user's past transactions and/or about transactions occurring after the authorization is received. The third-party systems 108 may periodically provide the transaction information or may provide transaction information when the transactions are made. The third-party systems 108 may provide transaction information for transactions occurring during a period of time. For example, the third-party systems 108 may provide transaction information 132 for transactions occurring in the past thirty days. In some embodiments, the third-party systems 108 provide transaction information for transactions made by social punch card members or transaction information for all transactions from a particular merchant or business. As discussed in more detail herein, a social punch card may receive one or more punches based on the transactions of the users that occurred before and/or after the users joined the social punch card.

The punch card update module 126 adds a number punches to a social punch card based on the number qualifying actions and/or transactions of a user associated with the social punch card and sends notifications to the users of the social punch card updating them on the progress of the social punch card. More specifically, the punch card update module 126 receives information about a user's actions and/or transactions (e.g., viewing user data 130 and/or transaction information 132), retrieves punch card information 134 for a social punch card associated with the user from the punch card database 116, determines whether any of the user's actions and/or transactions described in the received information qualifies as a punch for the social punch card, updates the social punch card with one or more punches corresponding to qualifying actions and/or transactions, and sends notifications containing information 138 about the updated social punch card to one or more communication channels 120 associated with the users of the social punch card.

The punch card update module 126 identifies the user from the viewing user data 130 and/or the transaction information 132. For example, the viewing user data 130 and/or the transaction information 132 may include an identifier that uniquely identifies the user or the user's profile. After identifying the user, the punch card update module 126 identifies a social punch card from the punch card database 116 associated with the user and retrieves punch card information 134 for the identified social punch card. In order to add punches to the social punch card, the punch card update module 126 determines whether the actions and/or transactions described in the viewing user data 130 and/or the transaction information 132 qualify as actions specified by punch card information 135. For example, for a movie punch card, a qualifying action may be purchase of a movie ticket within the last three months. The punch card update module 126 determines the number of qualifying actions from the viewing user data 130 and/or transaction information 132 and credits the social punch with one or more punches corresponding to the number of qualifying actions.

After crediting a social punch card with one or more punches, the punch card update module 126 sends notifications to the social punch card members to update them on the progress of the social punch card. If the target number of actions for the social punch card has not been reached, the notification includes information identifying the number of punches added to the card, the users who added punches to the card, and the number of remaining punches until the target number is reached. The notification may also include instructions on how to add punches to the social punch card, a message encouraging users to add punches to the social punch card, a link to a page for the social punch card, and a link to a page of the social networking system or webpage associated with the business sponsor of the social punch card. As discussed above, the notifications may be sent to the social punch card members and their friends in order to encourage users to engage with the social punch card or to spread awareness about the social punch card sponsor. The notification may be sent to the users through one or more communication channels and may be in the form of an overlay box, a message, pop-up notification, or a news story. In some embodiments, notifications include an interface that allows users to add a comment to the notification which is sent to the other social punch card members and/or their friends. For example, a user may add a comment to an overlay box or news story and the comment is sent to the other members of the social punch card and/or their friends.

If the target number of actions for the social punch card has been reached, the punch card update module 126 sends a notification to the communication channels 120 of the members of the social punch card indicating that target number of actions has been reached and information describing how the users will obtain their reward. As discussed above the notification may be send to the social punch card members and/or friends of the social punch card members. Additional aspects of the notifications have been described above.

The reward for reaching the target number of punches may be sent by the social networking system 100, the merchant systems 104, the financial intermediary systems 105, or the service providers 106. In some embodiments, the punch card update module 126 sends a message to the merchant systems 104, financial intermediary 105 systems, or service provider systems 106 indicating that social punch card members are eligible for a reward. The merchant systems 104, financial intermediary systems 105, or service provider systems 106 may credit a user's credit card account or other online account with the purchase price amount of an item. The social networking system 100 may credit a user's account with virtual currency or virtual items. The systems may also send a message or notification containing a redemption code or instructions on how to obtain the reward.

The punch card assignment module 124 assigns a user to a social punch card. A user may join a social punch card in various ways including being invited to a social punch card, requesting to join a particular social punch card, requesting to join a social punch card sponsored by a particular business, or requesting to join a social punch card without specifying a business that sponsors the card.

When the user is invited to join a social punch card, the punch card assignment module 124 assigns the user to the social punch card if there is an available member spot for the social punch card. The user may be invited by a member of the social punch card that is connected to the user.

When the user is invited to or requests to join a social punch card that does not have an available member spot, the punch card assignment module 124 selects a social punch card to assign to the user. A user may request to join a particular social punch card or may request to join a social punch card sponsored by a particular business. For example, a user may request to join a social punch card that has one or more of the user's friends as members or the user may request to join any social punch card provided by a particular smoothie business. It is noted that a business may sponsor multiple social punch cards at the same time. The punch card assignment module 124 determines scores for a set of social punch cards in the punch card database 116 and assigns the user to the social punch card with the highest score. In some embodiments, the scores are determined for a set of social punch cards that have at least one available member spot and at least one member who is connected to the user. In some embodiments, the score for a social punch card is based on the user's affinity for the members of the social punch card. The user's affinity for other users is determined by the affinity module 127 which is discussed in more detail herein. In some embodiments, the score for a social punch card is the sum of the user's affinity coefficients for members of the social punch card that are connected to the user. For example, if a user has three friends (e.g., friend A, friend B, and friend C) who are members of a social punch card, the punch assignment card module 124 retrieves the affinity coefficient between the user and each of the three friends (e.g., 0.4, 0.8, and 0.4) from the affinity module 127, determines the sum of the affinity coefficients (e.g., 0.4+0.8+0.4), and sets the sum as the user's score for the social punch card. In some embodiments, the score for a social punch card is the user's average affinity coefficient for the members of the social punch card that are connected to the user. In this way, a user is assigned to a social punch card with the user's close friends, which increases the likelihood that the user will be engaged with the social punch card. In some embodiments, the social punch card is selected based in part on the number of remaining punches until the target number of punches is reached. For example, the punch card assignment module 124 may select the social punch card with the highest score and the fewest remaining number of punches needed until the target number of punches is reached. This way, the user is assigned to a social punch card nearest to completion which may encourage the user to contribute punches to the social punch card.

When there are no social punch cards that have at least one member that is friends with the user and at least one available member spot, the punch card assignment module 124 may create a social punch card for the user. For example, if the user requests to join a social punch card sponsored by a smoothie business and there are no social punch cards sponsored by the smoothie business that have at least one available member spot and at least one member that is friends with the user, the punch card assignment module 124 may create a new social punch card for the user to join that is sponsored by the smoothie business. In some embodiments, the user may join a social punch card by selecting a social punch card or the business sponsor of the social punch card. For example, a user may select a social punch card from a list of social punch cards or the user may select a business from a list of businesses.

When the user request requests to join a social punch card without specifying a business sponsoring the card, the punch card assignment module 124 may select a social punch card for the user. For example, a user may hear about social punch cards and want to join any social punch card without specifying a business sponsor. In some embodiments, the punch card assignment module 124 determines a social punch card for the user based on the user's affinity for a business, brand, product, or service associated with the social punch card. For example, the punch card assignment module 124 may select a business that sells frozen yogurt based on the user's affinity for a particular brand of frozen yogurt or for frozen yogurt. In some embodiments, the punch card assignment module 124 uses collaborative filtering to determine a business the user would like based on the interests of users whose interests match the user.

After the punch card assignment module 124 assigns a social punch card to a user, the punch card assignment module 124 sends a notification to one or more communication channels 120 associated with the user's friends and/or members of the social punch card. The notification includes information indicating that the user has joined the social punch card, the remaining number of punches until the target number is reached, and describes how a user can add a punch to the social punch card. Additional aspects of the notifications have been described above.

The punch page module 129 provides a social punch card page to the members of a social punch card. The page may display a list of the members associated with the social punch card, the progress of the card, activity relating to the card (e.g., a user joining a card or adding one or more punches to the card), an interface to invite users to the social punch card, a composer interface for posting messages to the page, and messages from the social punch card members. Using the page, any card member may communicate with the other social card members. For example, the page may display a comment thread that includes messages from the card members encouraging each other to help complete the card. This way, a user does not have to send individual messages to the card members. The messaging between card members helps encourage the users to stay engaged with the social punch card promotion and the business sponsoring the card.

The affinity module 127 determines a user's affinity for objects (which includes members of social punch cards) in the social networking system 100. In one embodiment, affinity scores of users for an object may be determined by the social networking system 100 based on the user's interactions with the specified object over time. The affinity scores of users may be computed for various objects based on actions performed on those objects, such as sharing a link to the object, commenting on the object, installing the object, and the like, as further described in a related application, “Contextually Relevant Affinity Prediction in a Social Networking System,” U.S. patent application Ser. No. 12/978,265, filed on Dec. 23, 2010, which is hereby incorporated by reference.

The communication channels 120 may comprise one or more different information delivery methods, comprising a stream, a feed, a wall post, an email communication, a comment on a posted content item, a mobile application, a note, a third-party application, a text message, a third-party website, an advertising communication channel, a discussion board, or any other communication channel that exists or is associated with the social networking service. A discussion board may reside on many different types of objects, such as an event, a group, a fan page, and a photo album, just to name a few. Communication channels are discussed further in U.S. patent application Ser. No. 12/253,149, filed on Oct. 16, 2008, which is hereby incorporated by reference in its entirety.

### Overview of Social Networking Systems

Online social networking systems comprise one or more computing devices storing a social network, or a social graph, comprising a plurality of users and providing users of the social networking system with the ability to communicate and interact with other users of the social networking system. Social networking systems allow users to explicitly associate themselves and establish connections with other users of the social networking system. When two users become connected, they are said to be “friends,” “contacts,” “connections,” or “associates” within the context of the social networking system. Alternatively, connections may be automatically created by the social networking system based on common characteristics of the users (for example, users who have had a common employer, have a common friend, or like a common film). Generally, being connected in a social networking system allows connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, other user-generated content, and other computer-related files.

Online social networking systems may track objects through the use of a social graph, which includes a plurality of nodes that are interconnected by a plurality of edges. In the social graph, nodes represent objects within the context of the social networking system. Common examples of objects include users, content items, groups, web pages, fan pages, events, messages, concepts, interactions, information, activities, data, computer applications, advertisements, or any other entity capable of being represented in a social networking system. Companies, locations, venues, merchants, bands, non-user persons, restaurants, or any other entities may be directly represented by a social networking system object, or may be indirectly represented by an object via a group, web page or fan page within the social networking system dedicated to the entity. For instance, the restaurant “Refuge” or the venue “Orpheum Theatre” may have dedicated objects within the social networking system; alternatively, Refuge may have a fan page and the Orpheum Theatre may have a web page on the social networking system.

An edge between nodes in the social graph represents a particular kind of connection between the two nodes, which may result from an interaction that occurred between the nodes. For instance, for two nodes that represent users, an edge may imply that the users are friends within the context of the social networking system. Alternatively, an edge may imply that the users have communicated with each other, that one user may have viewed the other's profile, that the users attended the same high school, or any other means of connection or interaction. For two nodes where at least one node does not represent a user, an edge may imply similar or different connections or interactions. For example, an edge may indicate a user clicked the “like” button for a group dedicated to a particular band, or that a user clicked on an advertisement. Alternatively, an edge may indicate that two companies, each represented by a social networking system web page, are associated with each other despite no explicit action by either company.

When a new object of a particular type is created, the social networking system may initialize a new node of the corresponding type, may assign a unique object or node identifier to it, and may begin to add data to the object as needed. This might occur, for example, when an individual first becomes a user of the social networking system, when the social networking system generates a new user profile, when a user starts a new group, when a new content item is uploaded to the social networking system, or any other time an object is added to or created within the social networking system. When a new object is created, an edge may be created linking the object node to the node representing the user who created the object. In addition, the social networking system may link the new object node or any existing nodes to other social graph nodes automatically. For instance, if a first user uploads a photograph of a sports bar to the social networking system, and afterwards, a fan page for the sports bar is created, the social networking system may provide an edge between the user node and the fan page node without explicit action by a user. Further, if a second user posts a comment about going to the sports bar on a third user's profile, the second user's and third user's nodes may be automatically connected to the sports bar node without explicit action by either user in regards to the sports bar node.

Users of social networking systems may interact with social networking system objects in a variety of forms, such as by communicating with or commenting on a content item, information or action; clicking a button or link associated with approval (such as a “like” button or the equivalent); sharing a content item, user information or user actions with other users; or downloading or merely viewing a content item. Interaction may also comprise using a computer-based application within the context of the social networking system (such as a video game only accessible and playable from within the social networking system), or an application external to the social networking system (such as a desk top web browser or mobile application) that may or may not interface with the social networking system. Further, interactions also include making a purchase, either in the context of the social networking system, or external to the social networking system; joining, commenting on or subscribing to a social networking system group, web page or fan page; using a mobile device to transmit a current or past location to the social networking system (“checking in” to a location); scheduling a meeting, gathering, errand, vacation, task, objective, reservation, date, or any other event or calendar entry; and accepting an invitation to or indicating the intent to attend a meeting, gathering, party, concert, play, or any other event. For instance, a user may join a group dedicated to Chopin, may buy tickets to a Chopin performance, may check into the concert hall when the user arrives at the performance, and may post a note to the user's profile reviewing the performance, all of which constitute interactions.

Users of social networking systems may also interact with other users by associating with, connecting to or becoming friends with them, by viewing their profile, by communicating with them, or by having common friends within the social networking system. In addition, a social networking system user may interact with content items, websites, other users, or other information outside of the context of the social networking system's web pages that are connected to or associated with the social networking system. For instance, an article on a news web site might have a “like” button that users of the social networking system can click on to express approval of the article. Likewise, a company's website may provide the ability to join a social networking system group dedicated to the company directly from the company's website. These interactions and any other suitable actions within the context of a social networking system may be recorded in social networking system data, which can be used to generate social endorsement information. The social endorsement information may comprise text, images, links, and/or be of any suitable form necessary to convey social endorsement information to a user.

### System Environment

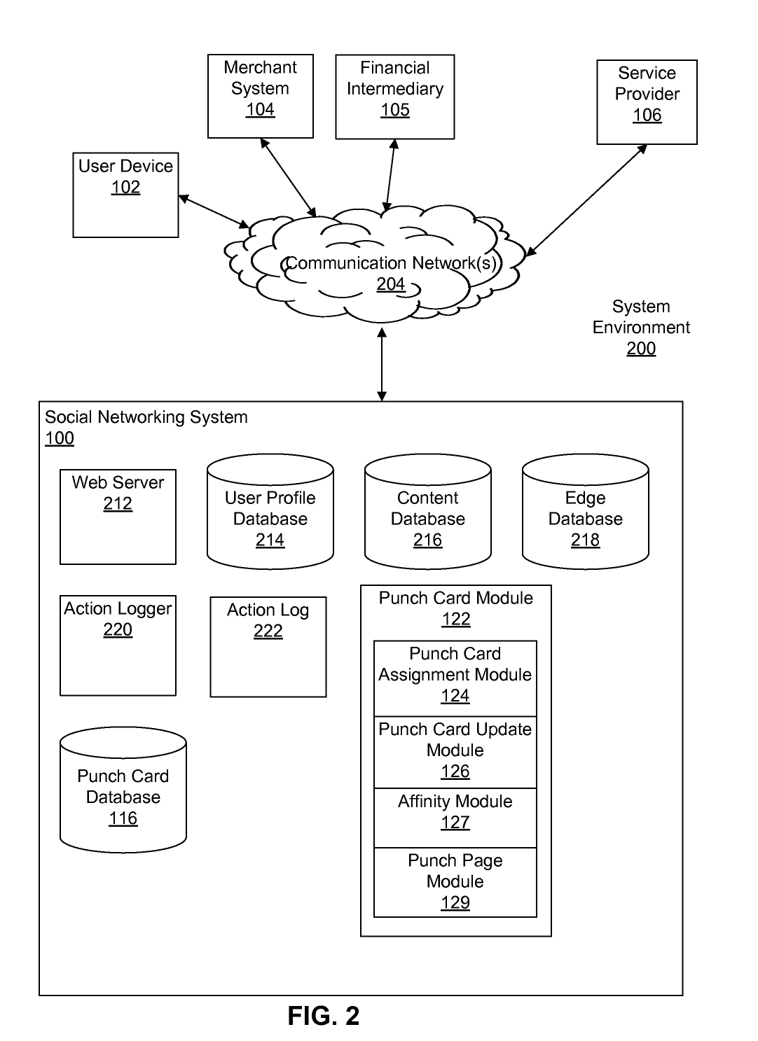

FIG. 2 is a high level block diagram illustrating a system environment 200, in accordance with one embodiment. The system environment 200 comprises one or more user devices 102, the social networking system 100, a network 204, one or more service providers 106, one or more merchant systems 104, and one or more financial intermediary systems 105. In alternative configurations, different and/or additional modules can be included in the system. In some embodiments, the social networking system 100 is implemented as a single server, while in other embodiments it is implemented as a distributed system of multiple servers. For convenience of explanation, the social networking system 100 is described below as being implemented on a single server system.

The communication network(s) 204 can be any wired or wireless local area network (LAN) and/or wide area network (WAN), such as an intranet, an extranet, or the Internet. It is sufficient that the communication network 204 provides communication capability between the user devices 102 and the social networking system 100. In some embodiments, the communication network 204 uses the HyperText Transport Protocol (HTTP) and the Transmission Control Protocol/Internet Protocol (TCP/IP) to transmit information between devices or systems. HTTP permits the user devices 102 to access various resources available via the communication network 204. The various embodiments of the invention, however, are not limited to the use of any particular protocol.

The user devices 102 comprise one or more computing devices that can receive user input and can transmit and receive data via the network 204. In one embodiment, the user device 102 is a conventional computer system executing, for example, a Microsoft Windows-compatible operating system (OS), Apple OS X, and/or a Linux distribution. In another embodiment, the user device 102 can be a device having computer functionality, such as a personal digital assistant (PDA), mobile telephone, smart-phone, etc. The user device 102 is configured to communicate via network 204. The user device 102 can execute an application, for example, a browser application that allows a user of the user device 102 to interact with the social networking system 100. In another embodiment, the user device 102 interacts with the social networking system 100 through an application programming interface (API) that runs on the native operating system of the user device 102, such as iOS and ANDROID.

The web server 212 links the social networking system 100 via the network 204 to one or more user devices 102; the web server 212 serves web pages, as well as other web-related content, such as Java, Flash, XML, and so forth. The web server 212 may provide the functionality of receiving and routing messages between the social networking system 100 and the user devices 102, for example, instant messages, queued messages (e.g., email), text and SMS (short message service) messages, or messages sent using any other suitable messaging technique. The user can send a request to the web server 212 to upload information, for example, images or videos that are stored in the content database 216. Additionally, the web server 212 may provide API functionality to send data directly to native user device operating systems, such as iOS, ANDROID, webOS, and BlackBerry OS.

The action logger 220 is capable of receiving communications from the web server 212 about user actions on and/or off the social networking system 100. The action logger 220 populates an action log 222 with information about user actions that users have given informed consent to collect. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log 222 may be used by a social networking system 100 to track users' actions on the social networking system 100 as well as external websites that communicate information back to the social networking system 100. As mentioned above, users may interact with various objects on the social networking system 100, including commenting on posts, sharing links, and checking-in to physical locations via a mobile device. The action log 222 may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log 222 records data about these users, including viewing histories, advertisements that were clicked on, purchasing activity, and buying patterns.

User account information and other related information for users are stored as user profile objects in the user profile database 214. The user profile information stored in user profile database 214 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile database 214 also maintains references to the actions stored in an action log 222 and performed on objects in the content database 216.

The edge database 218 stores the information describing connections between users and other objects on the social networking system 100 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge database 218 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge database 218, in one embodiment. For example, a user that plays multiple songs from Lady Gaga's album, “Born This Way,” may have multiple edge objects for the songs, but only one edge object for Lady Gaga.

### Updating a Social Punch Card

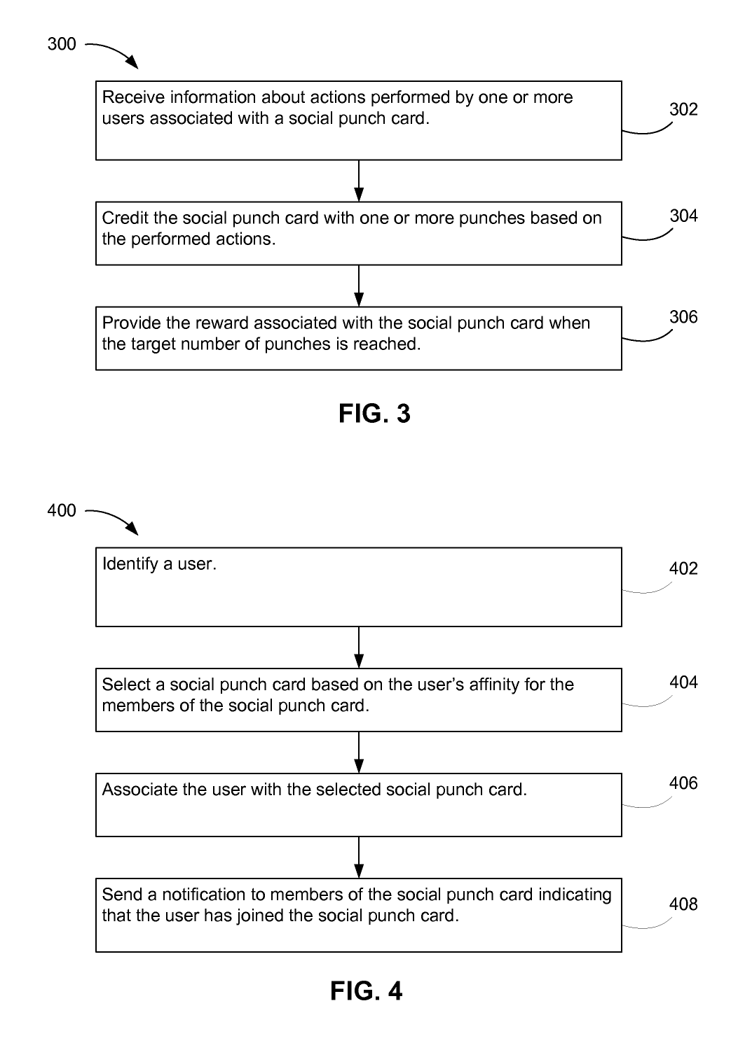

FIG. 3 is a flow chart of a process 300 for updating a social punch card, in accordance with one embodiment. The process 300 is performed at a server system (e.g., social networking system 100) having one or more processors and non-transitory memory. The non-transitory memory stores one or more programs to be executed by the one or more processors. The one or more programs include instructions for process 300.

In this process, information about actions performed by one or more users associated with a social punch card is received 302. The information may include transaction information 132 or viewing user data 132.

The social punch card is credited 304 with one or more punches based on the performed actions. As discussed above, the punch card update module 126 determines the number of qualifying actions from the received information and credits the social punch card with a number of punches corresponding to the number of qualifying actions. In some embodiments, a news story is posted to the newsfeeds associated with the members of the social punch card indicating that the social punch card was credited with one or more punches. The news story may also indicate the user who was responsible for the social punch card being credited with the one or more punches, the remaining number of punches until the target number of punches is reached, and a description of the reward associated with the social punch card. The notification may encourage other users to join a social punch card or may encourage current members of a social punch card to engage in activities that would result in punches being added to the social punch card.

The reward associated with the social punch card is provided 306 to the users associated with the social punch card when the target number of punches for the social punch card is reached. The reward or information on how to obtain the reward may be provided to the members of the social punch card through one or more communication channels 120 discussed above. As discussed above, the reward may be provided to user by a merchant system 104, financial intermediary system 105, or service provider system 106. For example, the systems may credit a user's credit card account or online account with a financial value of the reward. The systems including the social networking system may also provide the user with a redemption code or provide information about how to obtain the reward.

In some embodiments, a news story is posted to the newsfeeds associated with the members of the social punch card indicating that the target number of punches for the social punch card has been reached. In some embodiments, a news story is posted to the newsfeeds associated with friends or connections of the members of the social punch card, where the news story indicates that the members of the social punch card received a reward. This way, the friends of the users are encouraged to participate in social punch cards.

### Assigning a User to a Social Punch Card

FIG. 4 is a flow chart of a process 400 for assigning a social punch card to a user, in accordance with one embodiment. The process 400 is performed at a server system (e.g., social networking system 100) having one or more processors and non-transitory memory. The non-transitory memory stores one or more programs to be executed by the one or more processors. The one or more programs include instructions for process 400.

In this process 400, a user is identified 402. The user may be identified from a user identifier contained in a request from the user to join a social punch card, from a user identifier in cookie, or from an user identifier in an invitation from a friend of the user to join a social punch card. The social networking system 100 may request a cookie from the user device 102 and receive the cookie or a message associated with the cookie.

A social punch card is selected 404 based on the identified user's affinity coefficient for the members of the social punch card. As discussed above, the punch card assignment module 124 may determine a score for each incomplete punch card and select an incomplete punch card to assign to the user. In some embodiments, the score for a social punch card is based on the user's affinity coefficient for the members of the social punch card that are friends with the user. In some embodiments, the score for a social punch card is based on the user's average affinity coefficient for the members of the social punch card that are friends with the user. In some embodiments, the social punch card is selected based in part on the number of remaining punches needed until the target number of punches is reached for the social punch card. For example, the social punch card that has the highest score and the fewest remaining punches may be selected.

The user is associated 406 with the selected social punch card and a notification is sent 408 to the members of the selected social punch card indicating that the user has joined the social punch card. In some embodiments, the notification is sent to the joining user's connections and/or the social punch card members' connections. The notification may encourage other users to join the social punch card. The notifications may also encourage current members to engage in activity that would add more punches to a social punch card.

### Example Screenshot

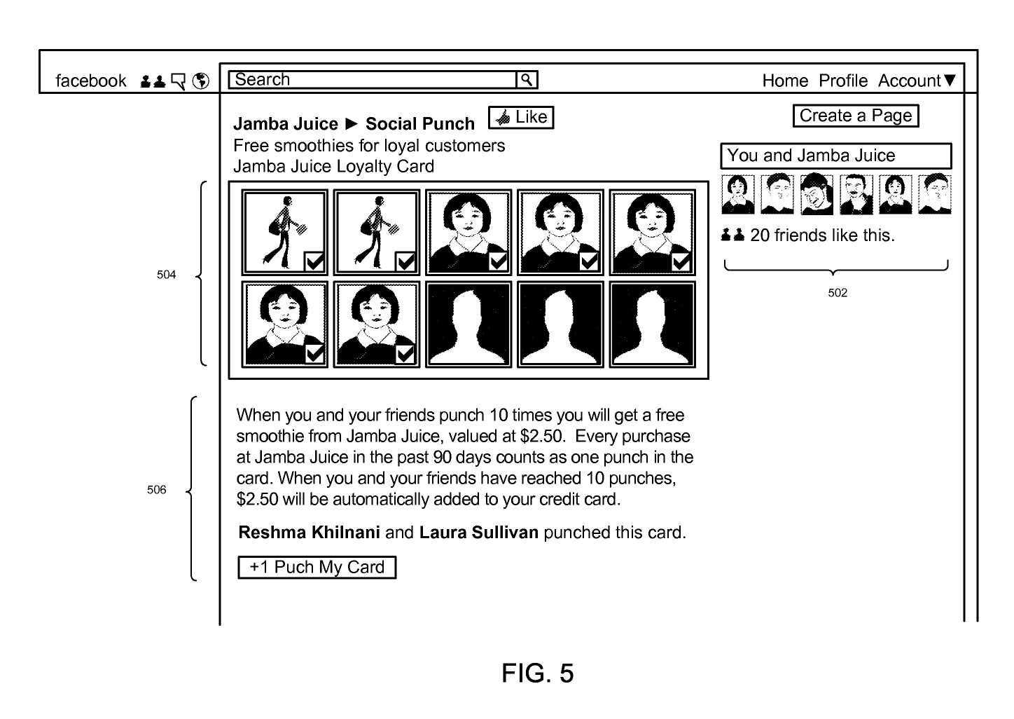

FIG. 5 is a screenshot 500 of a social punch card page that includes information associated with the social punch card. The screenshot 500 displays a list 502 of the members of a social punch card, a table 502 showing the progress of the social punch card, and a description 506 of how to qualify for the reward associated with the social punch card. As shown in FIG. 5, the table 502 displays seven profile pictures corresponding to seven punches of the social punch card and three default profile pictures to indicate that three additional punches are required to reach the target number of punches. The description 506 describes the qualifying actions for a punch, the time period in which the qualifying action needs to take place in order to be counted as a punch, the target number of punches for the card, and a description of the reward.

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

What is claimed is:

1. A method comprising:
maintaining a social punch card in a social networking system, the social punch card including a definition of an action that will credit a punch to the social punch card, a target number of punches for completing the punch card, and a reward to be provided for reaching the target number of punches;
associating a plurality of users of the social networking system with the social punch card, wherein each user associated with the social punch card has established a connection in the social networking system with at least one other user associated with the social punch card;
receiving information indicating that one or more of the users associated with the social punch card have performed the action;
crediting the social punch card with one or more punches based on the actions performed; and
responsive to the target number of punches reached for the social punch card, providing the reward to the users associated with the social punch car.

2. The method of claim 1, wherein the information describes a purchase by the user of an item or service.

3. The method of claim 1, wherein the information describes one or more actions performed on the social networking system.

4. The method of claim 1, further comprising:
posting a story indicating that the punch card was credited with one or more punches in newsfeeds of the plurality of users associated with the punch card.

5. The method of claim 1, further comprising:
posting a story indicating that the social punch card has reached the target number of punches when the social punch card has the target number of punches.

6. The method of claim 1, further comprising:
posting a story in newsfeeds associated with connections of the plurality of users associated with the social punch card indicating that the members of the social punch card received the reward.

7. The method of claim 1, further comprising:
posting a story indicating that one or more users redeemed the reward associated with the social punch card in the newsfeeds of the plurality of users associated with the social punch card.

8. The method of claim 1, further comprising:
identifying a viewing user;
determining a social punch card score for each of a plurality of incomplete social punch cards maintained by the social networking system, wherein a social punch card score for a respective incomplete social punch card is based on the viewing user's affinity for members of the incomplete social punch card, wherein an incomplete social punch card has at least one available member spot;
selecting an incomplete social punch based on the social punch card score for the incomplete social punch card;
assigning the viewing user to the selected incomplete social punch card; and
sending a notification to the members of the selected incomplete social punch card indicating that the viewing user is now a member.

9. The method of claim 8, wherein a social punch card score for a respective incomplete social punch card is based on the viewing user's affinity for members of the incomplete social punch card that are friends with the viewing user.

10. The method of claim 8, wherein an incomplete social punch card is selected based in part on a number of remaining punches until a target number of punches is reached.

11. The method of claim 8, wherein the selected incomplete social punch card has at least one member that is friends with the viewing user.

12. A computer program product comprising a non-transitory computer-readable storage medium containing computer program code for causing a processor to perform instructions comprising:
maintaining a social punch card in a social networking system, the social punch card including a definition of an action that will credit a punch to the social punch card, a target number of punches for completing the punch card, and a reward to be provided for reaching the target number of punches;
associating a plurality of users of the social networking system with the social punch card, wherein each user associated with the social punch card has established a connection in the social networking system with at least one other user associated with the social punch card;
receiving information indicating that one or more of the users associated with the social punch card have performed the action;
crediting the social punch card with one or more punches based on the actions performed; and
responsive to the target number of punches reached for the social punch card, providing the reward to the users associated with the social punch car.
